(19) United States
(12) Patent Application Publication
(10) Pub. No.: US 2008/0102365 A1
(43) Pub. Date: May 1, 2008

(54) End cap seal assembly for an electrochemical cell

(76) Inventor: Robert A. Yoppolo, New Milford, CT (US)

Correspondence Address: MR. BARRY D. JOSEPHS;ATTORNEY AT LAW, 19 NORTH STREET, SALEM, MA, 01970, US

(21) Appl. No.: 11/590,561

(22) Filed: Oct. 31, 2006

(51) Int. Cl. H01M 2/08; H01M 2/12

(52) U.S. Cl. 429/174; 429/181; 429/56

(57) ABSTRACT

An end cap seal assembly for an electrochemical cell such as an alkaline cell is disclosed. The end cap assembly comprises a metal support disk and underlying insulating sealing disk and a metal end cap overlying the metal support disk. The edge of the end cap and metal support disk is captured by the crimped edge of the insulating sealing disk. The support disk has a downwardly extending wall with at least one aperture therethrough. The insulating disk has a slanted downwardly extending wall forming a rupturable membrane which underlies and abuts the inside surface of the downwardly extending wall of the support disk. The rupturable membrane underlies and abuts the aperture in the downwardly extending wall of the end cap. When gas pressure within the cell exceeds a predetermined level the rupturable membrane pushes through said aperture and ruptures allowing gas to escape therefrom to the environment.

### FIELD OF THE INVENTION

The invention relates to an end cap assembly for sealing electrochemical cells, particularly alkaline cells. The invention relates to rupturable devices within the end cap assembly which allow gas to escape from the interior of the cell to the environment.

### BACKGROUND

Conventional electrochemical cells, such as alkaline cells, are formed of a cylindrical housing having an open end and an end cap assembly inserted therein to seal the housing. Conventional alkaline cells typically comprise an anode comprising zinc, a cathode comprising manganese dioxide, and an alkaline electrolyte comprising aqueous potassium hydroxide. After the cell contents are supplied, the cell is closed by crimping the housing edge over the end cap assembly to provide a tight seal for the cell. The end cap assembly comprises an exposed end cap which functions as a cell terminal and typically a plastic insulating plug, which seals the open end of the cell housing. A problem associated with design of various electrochemical cells, particularly alkaline cells, is the tendency of the cell to produce gases as it continues to discharge beyond a certain point, normally near the point of complete exhaustion of the cell's useful capacity.

Electrochemical cells, particularly alkaline cells, may be provided with a rupturable venting mechanism which includes a rupturable diaphragm or rupturable membrane within an end cap assembly. The rupturable diaphragm or membrane may be formed within a plastic insulating member as described, for example, in U.S. Pat. No. 3,617,386. Such diaphragms are designed to rupture when gas pressure within the cell exceeds a predetermined level. The end cap assembly may be provided with vent holes for the gas to escape when the diaphragm or membrane is ruptured. The end cap assembly disclosed in U.S. Pat. No. 3,617,386 discloses a grooved rupturable seal diaphragm and a separate metal contact disk between the end cap and seal diaphragm. The end cap assembly disclosed in the reference is not designed to withstand radial compressive forces and will tend to leak when the cell is subjected to extremes in hot and cold climate.

In order to provide a tight seal contemporary prior art disclose end cap assemblies which include a metal support disk inserted between the end cap plate and an insulating member. The separate metal support disk may be radially compressed when the cell housing edge is crimped over the end cap assembly. The insulating plug is typically in the form of a plastic insulating disk which extends from the center of the cell towards the cell housing and electrically insulates the metal support disk from the cell housing. The metal support disk may have a highly convoluted surface as shown in U.S. Pat. Nos. 5,759,713 or 5,080,985 which assures that end cap assembly can withstand high radial compressive forces during crimping of the cell's housing edge around the end cap assembly. This results in a tight mechanical seal around the end cap assembly at all times.

The prior art discloses rupturable vent membranes which are integrally formed as thinned areas within the insulating disk included within the end cap assembly. Such vent membranes are normally oriented such that they lie in a plane perpendicular to the cell's longitudinal axis, for example, as shown in U.S. Pat. No. 5,589,293. In U.S. Pat. No. 4,227,701 the rupturable membrane is formed of an annular “slit or groove” located in an arm of the insulating disk which is slanted in relation to the cell's longitudinal axis. The insulating disk is slideably mounted on an elongated current collector running therethrough. As gas pressure within the cells builds up the center portion of the insulating disk slides upwards towards the cell end cap, thereby stretching the thinned membrane “groove” until it ruptures. U.S. Pat. Nos. 6,127,062 and 6,887,614 B2 disclose an insulating sealing disk and an integrally formed rupturable membrane therein which is inclined. The rupturable membrane portion in the sealing disk abuts an aperture in the overlying metal support disk. When the gas pressure within the cell rises the membrane ruptures through the aperture in the metal support disk thereby releasing the gas pressure which passes to the external environment.

In U.S. Pat. No. 6,887,614 the rupturable membrane abuts an opening in an overlying metal support disk. In U.S. Pat. No. 6,887,614 there is an undercut groove on the underside of the membrane. The groove circumvents the cell's longitudinal axis. The groove creates a thinned membrane portion at its base which ruptures through the opening in the overlying metal support disk when the cell's internal gas pressure reaches a predetermined level. In the design shown in U.S. Pat. No. 6,887,614 there is an insulating washer which separates the exposed end cap from the cell housing. Such design has the disadvantage of requiring an additional component, namely, the insulating washer which needs to be inserted into the end cap assembly. The edge of the end cap sits over the cell housing shoulder and is separated from the housing by the washer. This allows for tampering of the end cap, that is, the end cap may be readily pried away from the cell allowing easier access to the cell contents.

The rupturable membrane can be in the form of one or more “islands” of thin material within the insulating disk as shown in U.S. Pat. No. 4,537,841; U.S. Pat. No. 5,589,293; and U.S. Pat. No. 6,042,967. Alternatively, the rupturable membrane can be in the form of a thin portion circumventing the cell's longitudinal axis as shown in U.S. Pat. No. 5,080,985 and U.S. Pat. No. 6,991,872. The circumventing thinned portion forming the rupturable membrane can be in the form of slits or grooves within the insulating disk as shown in U.S. Pat. No. 4,237,203 and U.S. Pat. No. 6,991,872. The rupturable membrane may also be a separate piece of polymeric film which is sandwiched between the metal support disk and the insulating disk and facing apertures therein as shown in Patent Application Publication US 2002/0127470 A1. A pointed or other protruding member can be oriented above the rupturable membrane to assist in rupture of the membrane as shown in U.S. Pat. No. 3,314,824. When gas pressure within the cell becomes excessive, the membrane expands and ruptures upon contact with the pointed member, thereby allowing gas from within the cell to escape to the environment through apertures in the overlying terminal end cap.

A separate metal support disk, typically with convoluted surfaces as shown in U.S. Pat. Nos. 5,080,985 and 5,759,713, has been included within the end cap assembly. The metal support disk provides support for the plastic insulating seal and withstands high radial compressive forces which may be applied to the end cap assembly during crimping of the housing edge around the end cap assembly. The high radial compressive force assures that the seal along the peripheral edge of the end cap assembly and cell housing can be maintained even if gas pressure within the cell builds up to elevated levels a very high level, for example, over 1000 psig (689.4×10⁴ pascal gage).

In U.S. Pat. No. 4,537,841 is shown a plastic insulating seal for closing the open end of a cylindrical alkaline cell. There is a metal support disk over the insulating seal. The plastic insulating seal has a central hub and integrally formed radial arm which extends radially from the hub to the cell's casing wall. An “island” type rupturable membrane is formed integrally within the radially extending arm of the insulating seal. The “island” rupturable membrane is formed by stamping or compressing a portion of the radially extending arm of the insulating seal thereby forming a small circular thinned island portion, which is designed to rupture when gas pressure within the cell reaches a predetermined level. The island rupturable membrane shown in this reference is level with the radially extending arm of the insulating seal, that is, it is oriented in a plane perpendicular to the cell's central longitudinal axis. The top surface of the thinned rupturable membrane (facing the cell's open end) is very nearly level with the top surface of the radially extending insulating arm. This design while effective provides only a small limited space between the rupturable membrane and the metal support disk. When the cell is subjected to intentionally abusive conditions such as exposure to fire, this may result in very quick rise in cell internal temperature and gassing. It is possible under such extreme condition that the membrane may balloon out without rupturing because the membrane softens and there is only a small space between the membrane and the metal support disk.

In view of improvements in gassing inhibitors and in particular the use of multiple gassing inhibitors, modern alkaline cells can be designed to vent at somewhat lower pressures than in the past. That is, there has been a trend towards lowering the design activation pressures for venting mechanisms in alkaline cells. Lower design vent activation pressures poses design challenges. If an “island” type rupturable membrane is used to trigger the venting mechanism, there are practical limitations as to how thin such membrane can be molded using conventional molding techniques such as injection molding. Also there are limitations on the amount of surface area available for such membranes depending on cell size.

Accordingly, it is desirable to have an end cap assembly which provides a tight seal for the cell even though the cell may be exposed to extremes in both hot and cold climate.

It is desired to have a reliable rupturable venting mechanism within the end cap assembly which activates and functions properly even when the cell is subjected to abusive conditions.

It is desirable that the rupturable venting mechanism occupy minimal amount of space within the cell so that the cell can be filled with additional amounts of anode and cathode material, thereby increasing the cell's capacity.

It is desirable that the end cap be tamper proof, that is, cannot be readily pried from the end cap assembly.

It is desirable that the peripheral edge of the insulating sealing disk may be simultaneously crimped over both edges of the metal support disk and the end cap while maintaining a flush or nearly flush orientation between the downwardly extending walls of the insulating sealing disk and overlying metal support disk.

It is desired that and rupturable venting mechanism be readily manufactured and reliable so that venting occurs at a specific predetermined pressure level.

### SUMMARY OF THE INVENTION

The invention is directed to an electrochemical cell, for example an alkaline cell, comprising an end cap seal assembly inserted into the open end of a cylindrical housing (casing) for the cell. In one aspect the end cap assembly comprises a metal support disk and an underlying insulating sealing disk (insulating grommet) underlying the metal disk when the cell is viewed in vertical position with the metal support disk on top. The end cap assembly also comprises a terminal end cap positioned over the metal support disk.

The metal support disk is preferably formed of a disk of single piece metallic construction having a convoluted surface and at least one aperture through its surface. The insulating sealing disk has a convoluted surface wherein a portion of its surface underlies the aperture in the metal support disk when the cell is viewed in vertical position with the end cap assembly on top. The portion of said insulating sealing disk underlying said aperture has a groove on the inside surface thereof preferably facing the cell interior. The groove having an open end and opposing closed base wherein the base of the groove forms a thinned rupturable membrane. The rupturable membrane abuts the aperture in the metal support disk. When gas pressure within the cell rises said rupturable membrane penetrates through said aperture and ruptures thereby releasing gas directly into the surrounding environment through said aperture.

The insulating sealing disk comprises a plastic material having a downwardly extending wall slanted at an angle less than 90 degrees from the cell's central longitudinal axis and not parallel with said longitudinal axis. The downwardly extending wall of said insulating disk extends downwardly from a high point on the surface of the insulating disk and towards a lower point on its surface which is closer to the cell interior when the cell is viewed in vertical position with the end cap assembly on top. The metal support disk also has a downwardly extending wall slanted at an angle less than 90 degrees from the cell's central longitudinal axis. The downwardly extending wall of the metal support disk extends downwardly from a high point on the surface thereof when the cell is viewed in vertical position with the end cap assembly on top. There is at least one aperture in said downwardly extending wall of the metal support member against which the rupturable membrane abuts. Preferably the downwardly extending wall of the insulating sealing disk can be slanted at an angle of between about 35 and 80 degrees from the cell's central longitudinal axis. The downwardly extending wall of the overlying metal support disk is desirably slanted at the same angle, preferably an angle between about 35 and 80 degrees from the cell's central longitudinal axis, as the downwardly extending wall of the insulating sealing disk. This allows the rupturable membrane portion of the downwardly extending wall of the insulating sealing disk to abut and lie flush against the aperture in the downwardly extending wall of the metal support member. The downwardly extending wall of the insulating sealing disk lies flush or nearly flush against the overlying downwardly extending wall of said metal support disk.

The groove on the inside surface of the downwardly extending wall insulating sealing disk forming the rupturable membrane portion is preferably made so that it circumvents the center of the insulating disk. At least the portion of such circumventing rupturable membrane abutting said aperture in the metal support disk ruptures when the cell pressure rises to a predetermined level. The rupturable membrane is preferably of nylon or polypropylene. The end cap assembly of the invention allows the burst aperture to be made large because of the inclined orientation of the downwardly sloping arm of the metal support disk. The undercut groove in the rupturable membrane allows for thinner membrane at the rupture point, that is, at the base of the groove. This in turn allows for a reduction in design rupture pressures and accompanying small cell housing wall thickness, e.g between about 4 and 12 mil (0.10 and 0.30 mm), thereby increasing the amount of cell internal volume available for active anode and cathode material. For example, the end cap assembly of the invention may allow for a cell housing wall thickness of between 4 and 8 mils (0.10 and 0.20 mm) for AA and AAA size cells and between about 10 and 12 mils (0.25 and 0.30 mm) for C and D size cells.

The metal support disk preferably has a substantially flat central portion with an aperture centrally located therein. Preferably, a pair of diametrically opposed same size apertures are located in the downwardly extending wall of the metal support disk. After the cell active components are inserted the end cap assembly is inserted into the cell's housing open end. The peripheral edge of the metal support disk and peripheral edge of the overlying end cap lie within peripheral edge 28 of insulating sealing disk. The edge of the housing at its open end is then crimped over peripheral edge of the insulating seal disk. The insulating sealing disk edge in turn simultaneously crimps over both the peripheral edge of the metal support disk and peripheral edge of the overlying end cap locking the end cap and metal support disk 40 securely in place over the insulating sealing disk. Thus, the insulating sealing disk, metal support disk 40 and overlying end cap become locked within the open end 15 of the housing thereby closing the cell housing. Surprisingly, the downwardly extending wall of the insulating disk is maintained in a flush or very nearly flush (contiguous) lie against the downwardly extending wall of the overlying metal support disk even though enough crimping force must be applied during crimping to assure that the peripheral edge of the insulating sealing disk crimps over both the metal support disk edge and the end cap edge holding both edges permanently locked therein. That is, the crimping forces do not disturb the flush or nearly flush lie of the downwardly extending wall of the insulating sealing disk against the overlying downwardly extending wall of the metal support disk.

The end cap assembly of the invention has an elongated anode current collector which has a head that passes through the central aperture in the metal support disk so that it can be welded directly to the underside surface of the end cap. The head of the anode current collector is preferably welded directly to the underside of the end cap by electric resistance welding. There is no other welding of end cap assembly components required. Laser welding need not be employed anywhere in the cell assembly, thereby making the cell assembly process more efficient.

There are several common features in the end cap assembly of the invention and the design shown in commonly assigned U.S. Pat. No. 6,887,614 B2 (Duprey) with respect to the orientation of the rupturable membrane abutting an aperture in the metal support disk and the use of a preferred undercut groove in the insulating seal to form the rupturable membrane portion. However, the end cap assembly of the invention represents an improvement over Duprey. In the end cap assembly of the invention the use of an insulating washer between the end cap and cell housing shoulder as shown in Duprey at FIG. 3 and as described therein at col. 9, lines 36-51, has been eliminated. This has resulted in an improved end cap assembly design with fewer components. Instead in the present invention the peripheral edge of the insulating sealing disk is crimped over both the edge of the end cap and the edge of the underlying metal support disk holding both metal support disk and end cap tightly locked in place within the cell housing. This renders the end cap tamper proof, that is, the end cap cannot be readily removed by prying its edge from the cell as when the edge of the end cap is separated from the housing by an insulating washer. The present end cap assembly of the invention also eliminates the need to first weld the anode current collector to the metal support disk and then weld the metal support disk in turn to the end cap as in Duprey at FIG. 3. In the end cap assembly of the invention the head of the anode current collector is welded directly to the end cap. There is no welding required between the metal support disk and any other component, thus simplifying cell assembly.

### BRIEF DESCRIPTION OF THE DRAWINGS

The invention will be better understood with reference to the drawings in which:

FIG. 1 is a pictorial cut-away view of the end cap assembly of the invention.

FIG. 1A is an elevational cross sectional view of the bottom portion of the cell.

FIG. 2 is an exploded view showing the components of the end cap assembly of the invention.

FIG. 3 is a top perspective view of the insulating sealing disk.

FIG. 4 is a top perspective view of the metal support disk.

FIG. 5 is a top perspective view of the end cap.

### DETAILED DESCRIPTION

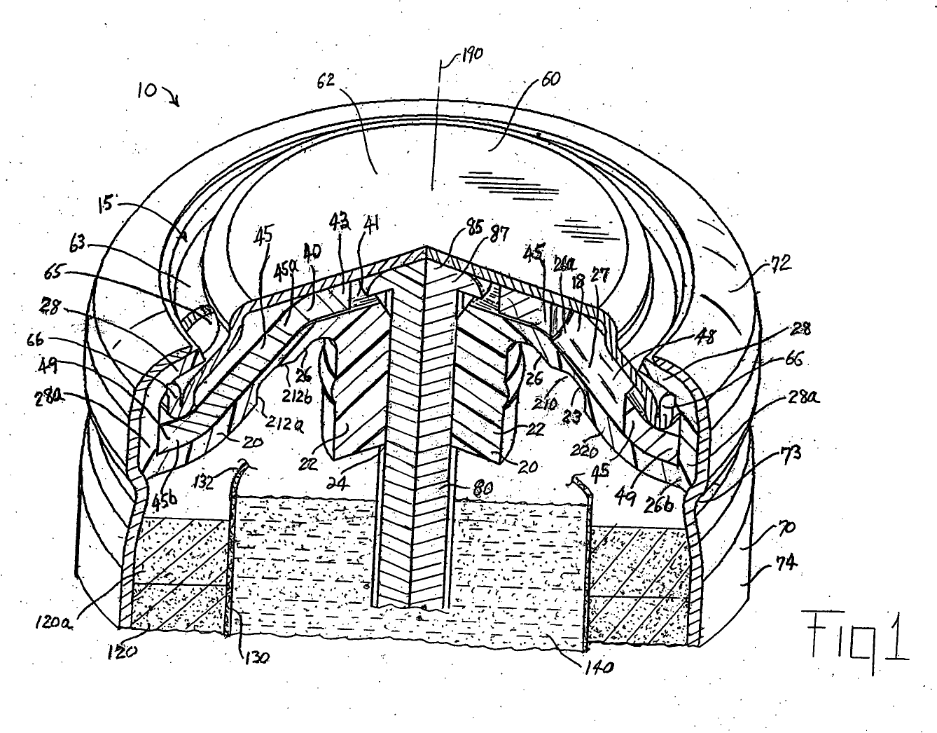

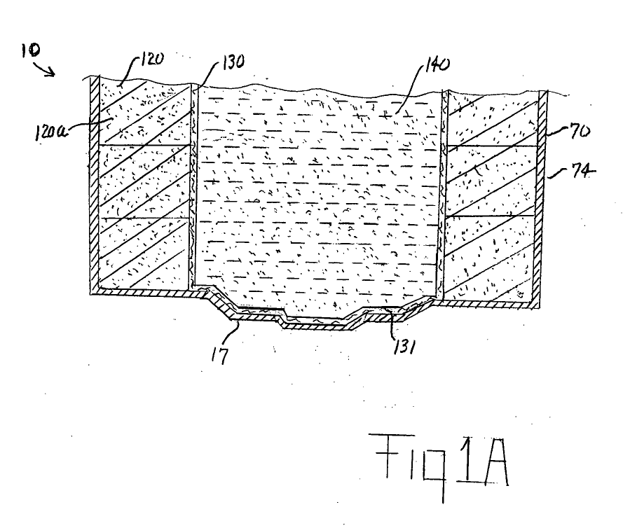

A preferred structure of the end cap assembly 14 of the invention is illustrated in FIG. 1. The end cap assembly 14 of the invention has particular applicability to electrochemical cells comprising a cylindrical housing 70 having an open end 15 and opposing closed end 17, wherein the end cap assembly 14 is inserted into said open end 15, to seal the cell. The end cap assembly 14 is particularly applicable to cylindrical alkaline cells of standard AAA (44×9 mm), AA (49×12 mm), C (49×25 mm) and D (58×32 mm) size. The end cap assembly 14 is particularly useful for smaller size alkaline cells such as AAA and AA size cell, but may be used advantageously in the C and D size cells as well. Such alkaline cells, as cell 10 (FIGS. 1 and 1A), desirably has an anode 140 comprising zinc, a cathode 120 comprising MnO₂, with electrolyte permeable separator 130 therebetween. The anode 140 and cathode 120 typically comprises an electrolyte of aqueous potassium hydroxide. The anode 140 may comprise zinc, the cathode 120 may comprise nickel oxyhydroxide, and the anode and cathode may comprise an electrolyte of aqueous potassium hydroxide.

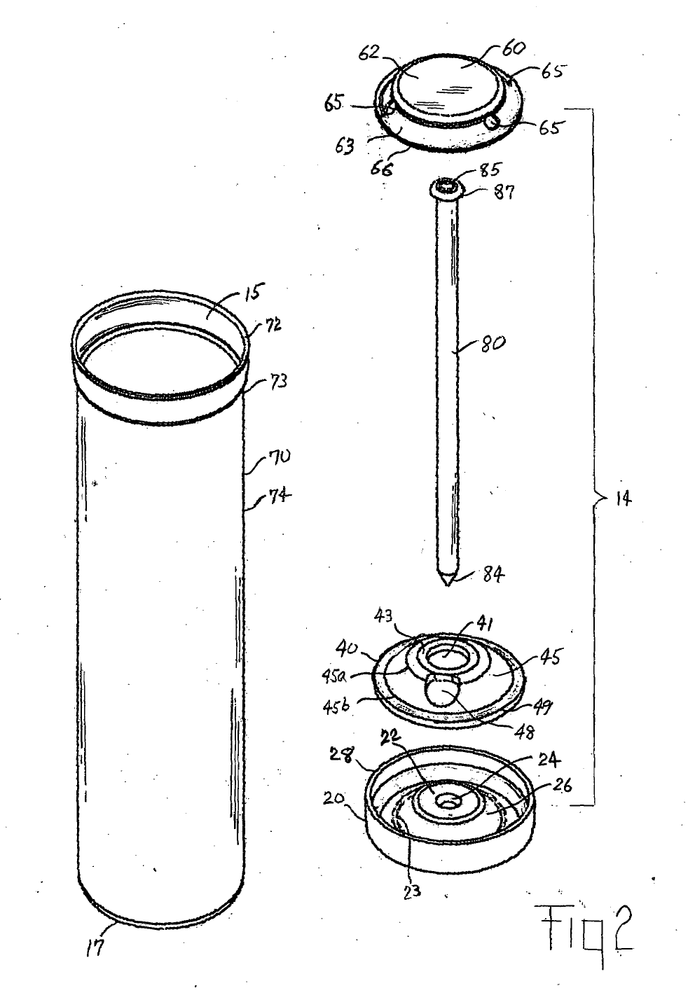

The end cap assembly 14 of the invention comprises a metal support disk 40, an underlying sealing disk 20, and current collector 80 penetrating through the central aperture 24 of sealing disk 20 and in contact with anode 140. A separate terminal end cap 60 of metal is stacked over the metal support disk 40 as shown in FIGS. 1 and 2. After cathode 120, separator 130 and anode 140 are inserted into housing 70, end cap assembly 14 is inserted into the housing open end 15. The peripheral edge 72 of housing 70 is crimped over peripheral edge 28 of insulating sealing disk 20. The peripheral edge 28 of the insulating sealing disk 20 is in turn crimped over both the peripheral edge 66 of the end cap 60 and the edge 49 of the metal support disk 40. In the crimping process radial forces may be applied assuring that the edge 66 of the end cap 60 bites into peripheral edge 28 of the insulating sealing disk 20. The edge 49 of metal support disk 40 may also bite into edge 28 of the insulating sealing disk 20.

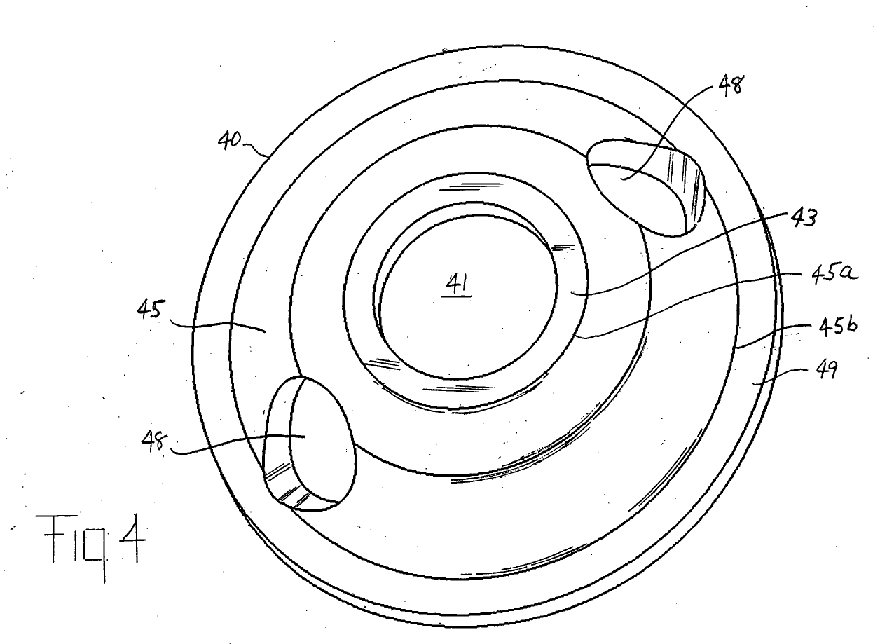

The metal support disk 40 (FIGS. 1 and 4) preferably has a substantially flat central portion 43 with an aperture 41 centrally located therein. The metal support disk 40 is preferably formed of a disk of single piece metallic construction having a convoluted surface. A portion of the metal support disk 40 has a downwardly sloping wall 45 and there is at least one burst aperture 48 therethrough. Metal support 40 is constructed of a conductive metal having good mechanical strength and corrosion resistance such as nickel plated cold rolled steel, stainless steel, or low carbon steel. The metal support disk 40 is preferably of carbon steel having a convoluted surface of about 0.50 mm thickness. Preferably, a pair of diametrically opposed same size apertures 48 are located in the downwardly extending wall 45 of the metal support disk 40 as shown best in FIG. 4. The downwardly extending wall 45 of the metal support disk 40 extends downwardly toward the cell interior from a high point 45a on the wall 45 of said support disk 40 to a low point 45b on said wall 45 when the cell is viewed in vertical position with the end cap assembly 14 on top. The downwardly extending wall 45 of support disk 40 is preferably straight in the direction of downward slope or can have a slightly convex surface contour (outward bulge) when viewed from outside the cell. Downwardly extending surface 45 terminates in peripheral edge 49.

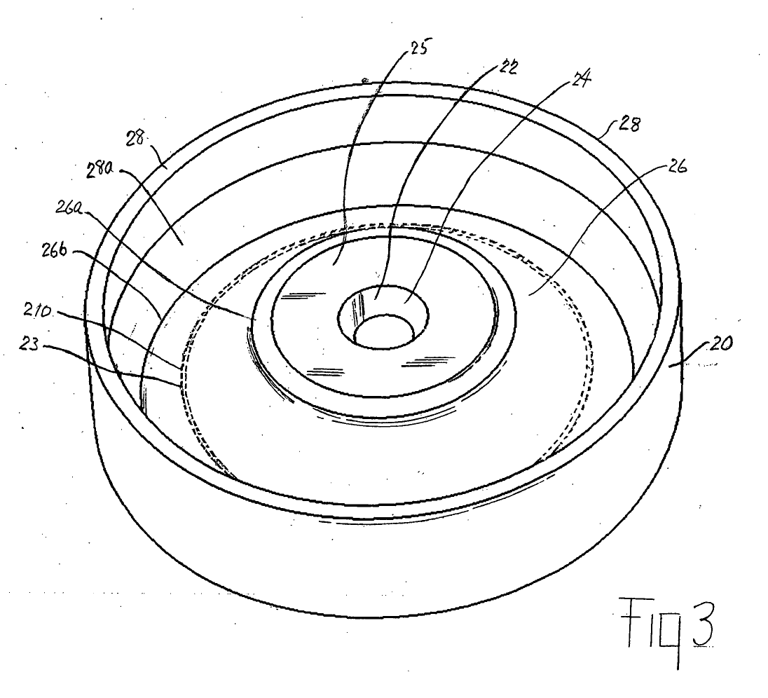

The insulating sealing disk 20 (FIGS. 1 and 3) has a convoluted surface including downwardly extending wall 26 wherein a portion of its surface underlies and abuts the aperture 48 in the metal support disk 40 when the cell is viewed in vertical position with the end cap assembly 14 on top. The wall 26 of the sealing disk 20 extends downwardly from a high point 26a on the surface thereof to a low point 26b on the surface thereof when the cell is viewed in vertical position with the end cap assembly 14 on top. Surface 26 of insulating disk 20 is preferably straight in the direction of downward slope (i.e. not bulging in or out) but may also have a slightly convex surface contour when viewed from outside the cell. Downwardly extending surface 26 terminates in upwardly extending peripheral edge 28.

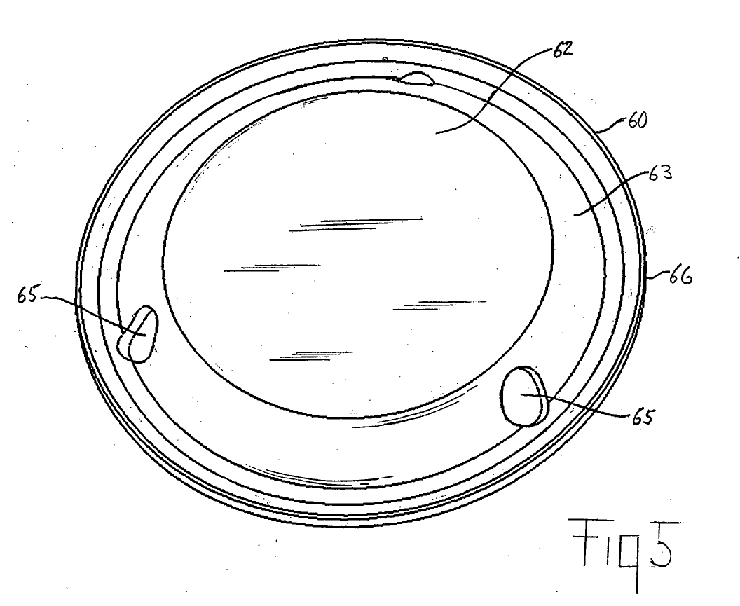

The portion of the downwardly extending surface 26 underlying said aperture 48 in the metal support disk 40 (FIG. 1) has an undercut groove 210 on the inside surface thereof facing the cell interior. The groove 210 has an open end and opposing closed base. The groove base forms a thinned rupturable membrane 23. The rupturable membrane 23 abuts the aperture 48 in the metal support disk 40. When gas pressure within the cell rises, said rupturable membrane 23 penetrates through said aperture 48 and ruptures thereby releasing gas into the head space 18 above the membrane 23, that is, the space between the membrane 23 and overlying end cap 60. The gas then passes to the external environment through vent apertures 65 in end cap 60 (FIGS. 1 and 5). Preferably, downwardly extending wall 26 of insulating disk 20 lies flush against the inside surface of downwardly extending wall 45 of metal support disk 40 during assembly. Surprisingly, downwardly extending wall 26 of insulating disk 20 is maintained in a flush or very nearly flush lie against the downwardly extending wall 45 of metal support disk 40 even though enough force must be applied during crimping to assure that the peripheral edge 28 of insulating sealing disk 20 is crimped tightly over both the metal support disk edge 49 and the end cap edge 66. That is, the crimping forces do not dislodge the substantially flush lie of downwardly extending wall 26 of insulating disk 20 against the downwardly extending wall 45 of metal support disk 40. The crimping forces do not create on average more than about 0.50 mm space between the downwardly extending walls 26 and 45, and typically the crimping forces do not create on average more than about 0.35 mm space between the downwardly extending walls 26 and 45. The crimping forces may typically create on average between about 0.1 mm and 0.50 mm space between the downwardly extending walls 26 and 45.

Groove 210 preferably runs circumferentially along the interior side 220 of the downwardly extending wall 26 as shown best in FIGS. 1 and 3. The groove 210 forms a thinned portion 23 running preferably circumferentially along the interior side (underside) of downwardly extending wall 26 of insulating sealing disk 20 (FIG. 1). Circumventing groove 210 (FIG. 1) forms a thinned portion, namely, circumventing membrane 23 at the base of groove 210. The thinned portion 23 forms a rupturable membrane which faces and preferably abuts downwardly extending wall 45 of the metal support disk 40 as shown in FIG. 1. There can be one or more apertures 48 in downwardly extending wall 45 of metal support disk 40 (FIGS. 1 and 4). Preferably there are two apertures in the surface of downwardly extending wall 45 as shown in FIG. 4. If two apertures 48 are employed they are desirably of about the same size and are located diametrically opposite each on downwardly extending wall 45 (FIG. 4). The portion of the circumventing thinned membrane 23 running directly under aperture 48 forms a rupturable portion. When gas within the cell builds up to a predetermined level, the portion of membrane 23 immediately under aperture 48 will stretch into the aperture until it ruptures under tension thereby releasing gas from within the cell. The cell's internal pressure is immediately reduced as the gas escapes to the environment through overlying end cap vent apertures 65.

The opposing groove walls 212a and 212b defining the depth of undercut groove 210 do not have to be of any particular shape of curvature. However, from the standpoint of ease of manufacture the groove walls 212a and 212b can be vertically oriented or may be slanted so that the mouth of groove 210 is wider than the base (rupturable membrane portion 23) of the groove. The angle of 212a does not play a factor in the rupturability of membrane 23, since the membrane is preferably intended to rupture in tension, not in shear. Walls 212a and 212b can be conveniently at right angle to rupturable membrane 23 at the base of groove 210 or can form an obtuse angle with the rupturable membrane 23 as shown in FIG. 1. Alternatively, groove walls 212a and 212b can be formed of flat or curved surface. Desirably, walls 212a and 212b each form flat surfaces forming an obtuse angle, desirably between about 120 and 135 degrees, with rupturable membrane 23 so the open end of the groove 210 is slightly wider than the groove base forming membrane 23. Such preferred embodiment gives circumventing groove 210 a trapezoidal shape as shown in FIG. 1. Such configuration is desirably from the standpoint of ease of manufacture by injection molding and does not effect the rupturability of membrane 23.

The downwardly extending wall 26 and rupturable membrane portion 23 therein is desirably slanted at an acute angle (angle less than 90°) from the cell's central longitudinal axis 190 as illustrated in FIG. 1. In such configuration downwardly extending wall 26 and membrane portion 23 therein is not parallel to the cell's central longitudinal axis. Preferably downwardly extending wall 26 is slanted at an acute angle between about 35 and 80 degrees from longitudinal central axis 190 (FIG. 1). Likewise, downwardly extending wall 45 of support disk 40 is preferably slanted at the same acute angle as the downwardly extending wall 26 of seal disk 20, namely between about 35 and 80 degrees from central axis 190. Thus, when the support disk 40 is placed over seal disk 20, the downwardly extending wall 45 of support disk 40 will abut and lie flush against the downwardly extending wall 26 of seal disk 20 and rupturable membrane 23 will abut aperture 48. As above indicated it has been determined that a flush (or very nearly flush) lie of the metal support disk downwardly extending wall 45 against the seal disk downwardly extending wall 26 can be maintained, despite the greater crimping forces needed to crimp the seal edge 28 over both end cap edge 66 and metal support edge 49 simultaneously. The slanted orientation of downwardly extending wall 45 of the metal support disk 40 allows larger diameter apertures 48 to be made in the downwardly extending wall 45 for a given overall height of support disk 40. This in turn allows the membrane 23 of a given small thickness to rupture at lower threshold pressure thereby allowing the cell housing 70 wall thickness to be reduced. Reduction in housing 70 wall thickness increases the cell internal volume available for anode and cathode active material thereby increasing cell capacity.

Insulating seal disk 20 may be formed of a single piece construction of plastic insulating material; preferably it is molded by injection molding nylon which is durable and corrosion resistant. As illustrated best in FIGS. 1 and 3, insulating disk 20 has a central boss or hub 22 with aperture 24 through the center thereof. Boss 22 forms the thickest and heaviest portion of disk 20. The peripheral edge of boss 22 terminates in downwardly extending wall 26 which extends downwardly from a high point 26a on said wall 26 to a low point 26b thereon when the cell is viewed in vertical position with the end cap assembly on top (FIGS. 1 and 3). Similarly, the peripheral edge of the center portion 43 of support disk 40 terminates in downwardly extending wall 45 from a high point 45a on said wall 45 to a low point 45b thereon (FIGS. 1 and 4).

The above described insulating seal disk 20 configuration also places the rupturable membrane 23 closer to the end cap 60. This means that there is more internal space available within the cell for active materials. Location of the rupturable membrane 23 on downwardly extending wall 26 of the insulating disk 20 permits gas and other internal components to pass unobstructed from the cell interior through aperture 48 in the metal support disk, then directly out to the environment through apertures 65 in the end cap 60 after membrane 23 ruptures. Such passage of gas from the cell interior to the environment is unobstructed even when the cell is connected to another cell or a device being powered.

In the absence of a groove forming a rupturable membrane in the seal, that is, if the entire portion of downwardly sloping wall 26 abutting aperture 48 is of uniform constant thickness and forms the rupturable membrane, the following relationship has been determined to apply approximately between the desired rupture pressure P_{R}, the radius “R” of the burst aperture 48, and thickness “t” of the resulting constant thickness membrane, where “S” is the ultimate tensile strength of the rupturable material.

Pᵣ=t/R×S (I)

It has been possible to reduce cell gassing through use of multiple gassing inhibitors. It is desirable to have the aperture 48 radius large and the thickness of the constant thickness membrane as small as possible. This allows rupture of the membrane if desired at lower threshold pressures, P, of gas buildup in the cells. Thus for a given cell size, there is a practical lower limit to the burst pressure determined by a maximum aperture radius and minimum membrane thickness achievable. The addition of an undercut groove 210 forming a rupturable membrane provides additional variables, such as groove depth and width, with which to manipulate the burst pressure to lower levels.

In the end cap assembly 14 the ratio of the rupturable membrane width (that is, the width of the base of groove 210) to the thickness of the rupturable membrane 23 is typically between about 2.5 to 1 and 12.5 to 1. The design of the end cap assembly 14 can accommodate an aperture 48 typically as large as between about 1.8 and 10 mm (circular diameter) in downwardly slanted wall 45 of metal support disk 40, for common cell sizes between AAA and D size cells.

The following lower level rupture pressures for membrane 23 are desirable in connection with the end cap assembly 14 of the invention. For AAA alkaline cells the target rupture pressure of membrane 23 is desirably between about 900 to 1800 psig (6.21 mega Pascal and 12.41 mega Pascal gage). For AA alkaline cells the target rupture pressure of membrane 23 is desirably between about 500 to 1500 psig (3.45 mega Pascal and 10.34 mega Pascal gage). For C size alkaline cells the target rupture pressure for membrane 23 is desirably between about 300 and 550 psig (2.07 mega Pascal and 3.79 mega Pascal gage). For D size alkaline cells the target rupture pressure for membrane 23 is desirably between about 200 and 400 psig (1.38 mega Pascal and 2.76 mega Pascal gage). Such rupture pressure ranges are intended as non limiting examples. It will be appreciated that the end cap assembly 14 is not intended to be limited to these rupture pressure ranges as the present end cap assembly 14 can be employed as well with higher and even lower rupture pressures.

With the above indicated rupture pressures ranges for the given cell size, housing 70 of nickel plated steel may typically have a small wall thickness, desirably between about 0.006 and 0.012 inches (0.15 and 0.30 mm), preferably between about 0.006 and 0.008 inches (0.15 and 0.20 mm) for the AA and AAA, and between about 0.010 and 0.012 inches (0.25 and 0.30 mm) for the C and D. The smaller wall thickness for housing 70 is desired, since it results in increased internal volume of the cell permitting use of more anode and cathode material, thereby increasing the cell's capacity. The end cap assembly 14 permits the above described rupture pressures to be achieved for the given cell size, and has an additional feature that the end cap 60 is “tamper proof”. That is, since the edge 66 of end cap 60 is crimped under the peripheral edge 28 of insulating sealing disk 20, it cannot be readily pried away from the end cap assembly. Thus, in the present end cap assembly 14 design, the cell contents as well are very secure and well protected against malicious tampering. Additionally, in the end cap assembly 14 of the invention the head 87 of anode current collector nail 80 is welded directly to the underside of end cap 60. This can be achieved by simple electric resistance welding. In the present end cap assembly 14 there is no need for welding of any other cell components, and there is no need for laser welding, thus simplifying cell construction.

In keeping with the desire to employ larger size apertures 48 in the context of end cap assembly herein described, it has been determined that this can be achieved best by orienting the insulating seal wall 26 containing rupturable membrane 23 at a slant, that is, not parallel to the longitudinal axis 190. Preferably, seal wall 26 and abutting metal support surface 45 are slanted downwardly at an angle, preferably between about 35 and 80 degrees from the central longitudinal axis 190. This provides more available surface area from which to form aperture 48.

In keeping with the desire to reduce the burst pressure of the cell, it has been determined that this can be achieved by forming an undercut groove 210 on the inside surface of downwardly sloping wall 26 of sealing disk 20. Such undercut groove 210 can be formed, for example, circumventing the center of sealing disk 20, during injection molding at the time of forming the sealing disk 20.

In a preferred embodiment employing a AA size alkaline cell, by way of nonlimiting example, the rupturable membrane 23 can be designed to rupture when gas within the cell builds up to a level of between about 500 to 1500 psig (3.45 mega Pascal and 10.34 mega Pascal gage). The rupturable membrane portion 23 underlying apertures 48 in metal support disk 40 is desirably formed of nylon, preferably nylon 66 or nylon 612, but can also be of other material such as polypropylene. Groove 210 can have a width between about 0.08 and 1 mm, desirably between about 0.08 and 0.8 mm. Groove 210 preferably runs circumferentially around the inside surface 220 of downwardly extending wall 26 of insulating disk 20. A segment of circumferential groove 210 runs immediately under apertures 48 in metal support disk 40. Alternatively, the groove 210 need not be circumventing but can be formed so that individual grooves are cut immediately under apertures 48 with the portions of the inside surface of wall 26 therebetween left smooth and uncut. The apertures 48 can be of circular shape having a diameter of between about 1.8 and 10 mm, corresponding to an area of between about 2.5 and 78.5 mm², typically between 2 and 9 mm (circular diameter), corresponding to an area between about 3.1 and 63.6 mm², for common cell sizes between AAA and D size cells. It should be recognized that apertures 48 can be of other shape such as oblong or elliptical. Apertures 48 can also be of rectangular or polygonal shape or irregular shapes comprising a combination of straight and curved surfaces. The effective diameter of such oblong or polygonal shape or other irregular shape is also desirably between about 2 and 9 mm. The effective diameter with such shapes can be defined as the minimum distance across any such aperture.

When the target rupturable pressure is between about 500 to 1500 psig (3.45 and 10.34 mega Pascal gage) for an AA cell or between about 900 to 1800 psig (6.21 and 12.41 mega Pascal gage) for an AAA size cell, the ratio of the groove width (width of membrane 23 at base of groove) to the thickness of rupturable membrane 23 is desirably between about 2.5:1 and 12.5:1. In keeping with this range of ratio, the groove width at the base of the groove is desirably between about 0.1 and 1 mm, preferably between about 0.4 and 0.7 mm and the thickness of rupturable membrane 23 is between about 0.08 and 0.25 mm, desirably between about 0.10 and 0.20 mm. The apertures 48 have can have a diameter typically between about 1.8 and 4.5 mm, corresponding to an area between about 2.5 and 16 mm².

When C and D alkaline cells are employed rupturable membrane 23 is desirably designed to rupture at lower pressures. For example, for C size cells the target rupture pressure may be between about 300 and 550 psig (2.07 and 3.79 mega Pascal gage). For D size cells the target rupture pressure may be between about 200 and 400 psig (1.38 and 2.76 mega Pascal gage). The same ratio of the groove width (width of membrane 23 at base of groove) to the thickness of rupturable membrane 23 is desirably between about 2.5:1 and 12.5:1 is also applicable.

In general irrespective of cell size, it is desirable to maintain a ratio of the thickness of the rupturable membrane 23 to the thickness of downwardly extending seal wall 26 immediately adjacent membrane 23 to be 1:2 or less, desirably between about 1:2 and 1:10, more typically between about 1:2 and 1:5. In such embodiment the rupturable membrane 23 thickness is desirably between about 0.08 and 0.25 mm, preferably between about 0.1 and 0.2 mm. The apertures 48 through which the membrane 23 ruptures desirably have a diameter between about 1.8 and 10 mm.

In assembly after the anode 140, cathode 120 and separator 130 are inserted into the cell housing 70, the end cap assembly 14 is inserted into the housing open end 14. The metal support disk 40 may first be pressed onto the insulating sealing disk 20 so that the top surface 43 of the boss 22 of sealing disk 20 penetrates into central aperture 41 of metal support disk 40. The downwardly extending wall 26 of the insulating disk 20 lies flush against the inside surface of downwardly extending wall 45 of the overlying metal support disk 40. The insulating sealing disk 20 with metal support disk 40 contained therein may then be inserted into the open end 15 of housing 70. The lower portion of the insulating seal peripheral edge 28 rests on circumferential bead 73 in the cell housing side wall 74. The head 87 of current collector nail 80 is welded, preferably by electric resistance welding, to the underside of end cap 60.

The current collector 80 is then inserted through aperture 41 in the metal support disk 40 and then through underlying central aperture 24 in the insulating sealing disk 20 until the tip 84 of the current collector penetrates into the anode 140 material. The underside of the attached end cap 60 comes to rest against the top flat surface 43 surrounding aperture 41 of metal support disk 40. Both edges 49 of the metal support disk 40 and edge 66 of the overlying end cap 60 lie within peripheral edge 28 of insulating sealing disk 20 as shown in FIG. 1. The edge 72 of the housing 70 is then crimped over peripheral edge 28 of the insulating seal disk 20. The insulating sealing disk edge 28 in turn crimps over both edge 49 of the metal support disk 40 and edge 66 of end cap 60 locking the end cap 60 and underlying metal support disk 40 securely in place over the insulating sealing disk 20. Thus, the insulating sealing disk 20, metal support disk 40 and overlying end cap 60 become locked within the open end 15 of the housing thereby closing the cell housing. Radial compressive forces may be applied to housing 70 during crimping to assure that the peripheral edge 66 of end cap 60 bites into the peripheral edge 28 of the insulating sealing disk 20 and that the metal support disk edge 49 becomes radially compressed thereby helping to achieve a tight seal. The edge of 66 of the end cap 60 is not accessible and thus the end cap 60 is considered to be tamper proof, that is, cannot be readily pried away from the cell assembly.

In another embodiment of the sealing disk 20, the disk configuration can be the same as shown in FIG. 1 and FIG. 3 except that groove 210 can be formed by cutting or stamping a die or knife edge, with or without the aid of a heated tool, into the underside 220 of downwardly extending wall 26 of sealing disk 20 after the disk is formed. In such embodiment the sealing disk 20 can be first formed by molding to obtain a downwardly extending wall 26 of uniform thickness, that is, without groove 210. A die having a circumferential cutting edge can then be applied to the underside surface 220 of the sealing disk downwardly extending wall 26. A circumferential or arcuate cut forming groove 210 of width less than 1 mm, desirably between about 0.08 and 1 mm, preferably between 0.08 and 0.8 mm can be made in this manner to the underside surface 220 of downwardly extending wall 26 of sealing disk 20. Groove 210 forms the rupturable membrane 23 at the base of groove. The rupturable membrane 23 formed by groove 210 forms a weak area in the surface of downwardly extending wall 220 of the sealing disk. Groove 210 can be made by the use of a cutting die, e.g., a die having a raised edge (knife edge) which is pressed onto the underside of downwardly extending wall 26. The groove 210 made in this manner allows the membrane 23 at the base of groove 210 to be formed thinner than if the groove 210 is molded into downwardly extending wall 26. Groove 210 formed by a cutting die can thus result in a rupturable membrane 23 of very small width and very small thickness. The membrane 23 formed by groove cut 210 (FIG. 1) can be designed to rupture at the desired target pressure by adjusting the depth the cut, which in turn forms a rupturable membrane 23 of a desired thickness at the base of the cut.

The membrane 23 formed by groove cut 210 abuts the underside of downwardly extending wall 45 of metal support disk 40. A portion of membrane 23 can underlie one or more apertures 48 in downwardly extending wall 45 of metal support disk 40 in the same manner as described with respect to the embodiment shown in FIG. 1. It will be appreciated that groove cut 210 (FIGS. 1 and 3) does not have to be in the shape of continuous closed circle, but can be an arcuate segment, preferably long enough so that the portion of groove 210 underlying aperture 48 is continuous over the width of aperture 48. That is, groove 210 does not have to extend to portions 220 (FIG. 1) of the downwardly extending wall 26 not overlaid by aperture 48.

In a specific embodiment, by way of a non limiting example, irrespective of cell size, the sealing disk 20 can be of nylon, and the groove cut 210 can have a width, typically between about 0.08 and 1.0 mm, preferably between about 0.08 and 0.8 mm. The membrane 23 formed at the base of the groove cut can have a thickness such that the ratio of the membrane 23 thickness to the thickness of the downwardly extending wall 26 immediately adjacent groove 210 is between about 1:10 and 1:2, preferably between about 1:5 to 1:2. In such embodiment the rupturable membrane 23 thickness may typically be between about 0.08 and 0.25 mm, desirably between about 0.1 and 0.2 mm.

It should also be appreciated that while nylon is a preferred material for insulating disk 20 and integral rupturable membrane portion 23, other materials, preferably hydrogen permeable, corrosion resistant, durable plastic material such as polysulfone, polypropylene or talc filled polypropylene is also suitable. The combination of membrane 23 thickness and aperture 48 size may be adjusted depending on the ultimate tensile strength of the material employed and level of gas pressure at which rupture is intended. It has been determined to be adequate to employ only one aperture 48 and corresponding one rupturable membrane 23. However, downwardly extending wall 45 in metal support disk 40 may be provided with a plurality of comparably sized apertures with one or more abutting underlying rupturable membrane portions 23. Preferably, two diametrically opposed apertures 48 in metal surface 45 can be employed as shown in FIG. 4. This would provide additional assurance that membrane rupture and venting would occur at the desired gas pressure.

The following is a description of representative chemical composition of anode 140, cathode 120 and separator 130 for an alkaline cell 10 which may employed irrespective of cell size. The following chemical compositions are representative basic compositions for use in cells having the end cap assembly 14 of the present invention, and as such are not intended to be limiting.

In the above described embodiments a representative cathode 120 can comprise manganese dioxide, graphite and aqueous alkaline electrolyte; the anode 140 can comprise zinc and aqueous alkaline electrolyte. The aqueous electrolyte comprises a conventional mixture of KOH, zinc oxide, and gelling agent. The anode material 140 can be in the form of a gelled mixture containing mercury free (zero-added mercury) zinc alloy powder. That is, the cell can have a total mercury content less than about 50 parts per million parts of total cell weight, preferably less than 20 parts per million parts of total cell weight. The cell also preferably does not contain any added amounts of lead and thus is essentially lead-free, that is, the total lead content is less than 30 ppm, desirably less than 15 ppm of the total metal content of the anode. Such mixtures can typically contain aqueous KOH electrolyte solution, a gelling agent (e.g., an acrylic acid copolymer available under the tradename CARBOPOL C940 from B.F. Goodrich), and surfactants (e.g., organic phosphate ester-based surfactants available under the tradename GAFAC RA600 from Rhône Poulenc). Such a mixture is given only as an illustrative example and is not intended to restrict the present invention. Other representative gelling agents for zinc anodes are disclosed in U.S. Pat. No. 4,563,404.

The cathode 110 can desirably have the following composition: 87-93 wt % of electrolytic manganese dioxide (e.g., Trona D from Kerr-McGee), 2-6 wt % (total) of graphite, 5-7 wt % of a 7-10 Normal aqueous KOH solution having a KOH concentration of about 30-40 wt %; and 0.1 to 0.5 wt % of an optional polyethylene binder. The electrolytic manganese dioxide typically has an average particle size between about 1 and 100 micron, desirably between about 20 and 60 micron. The graphite is typically in the form of natural, or expanded graphite or mixtures thereof. The graphite can also comprise graphitic carbon nanofibers alone or in admixture with natural or expanded graphite. Such cathode mixtures are intended to be illustrative and are not intended to restrict this invention.

The anode material 150 comprises: Zinc alloy powder 62 to 69 wt % (99.9 wt % zinc containing 200 to 500 ppm indium as alloy and plated material), an aqueous KOH solution comprising 38 wt % KOH and about 2 wt % ZnO; a cross-linked acrylic acid polymer gelling agent available commercially under the tradename “CARBOPOL C940” from B.F. Goodrich (e.g., 0.5 to 2 wt %) and a hydrolyzed polyacrylonitrile grafted onto a starch backbone commercially available commercially under the tradename “Waterlock A-221” from Grain Processing Co. (between 0.01 and 0.5 wt. %); dionyl phenol phosphate ester surfactant available commercially under the tradename “RM-510” from Rhone-Poulenc (50 ppm). The zinc alloy average particle size is desirably between about 30 and 350 micron. The bulk density of the zinc in the anode (anode porosity) is between about 1.75 and 2.2 grams zinc per cubic centimeter of anode. The percent by volume of the aqueous electrolyte solution in the anode is preferably between about 69.2 and 75.5 percent by volume of the anode. The cell can be balanced in the conventional manner so that the mAmp-hr capacity of MnO₂ (based on 308 mAmp-hr per gram MnO₂) divided by the mAmp-hr capacity of zinc alloy (based on 820 mAmp-hr per gram zinc alloy) is about 1.

The separator 130 can be a conventional ion porous separator consisting of cellulosic material. Separator may have an inner layer of a nonwoven material of cellulosic and polyvinylalcohol fibers and an outer layer of cellophane. Such a material is only illustrative and is not intended to restrict this invention. Current collector 80 is brass, preferably tin plated or indium plated brass to help suppress gassing.

Although the present invention has been described with respect to specific embodiments, it should be appreciated that variations are possible within the concept of the invention. Accordingly, the invention is not intended to be limited to the specific embodiments described herein but will be defined by the claims and equivalents thereof.

What is claimed is:

1. An electrochemical cell comprising a housing having an open end an opposing closed end and cylindrical side wall therebetween and an end cap assembly inserted into the open end of said housing closing said housing, said cell having a positive and a negative terminal,
wherein the end cap assembly comprises an insulating sealing disk, a support disk comprising metal overlying said insulating sealing disk, and an end cap comprising metal overlying said metal support disk, and an elongated current collector in electrical contact with said end cap, when the cell is viewed in vertical position with the end cap assembly on top, wherein said insulating sealing disk electrically insulates the support disk and end cap from the cell housing; wherein said housing has an edge at the open end thereof and said insulating sealing disk, metal support disk, and end cap each have a peripheral edge; wherein said support disk is of single piece metallic construction and at least one aperture therethrough; wherein the edge of said housing at the open end thereof is crimped over the peripheral edge of said insulating sealing disk locking said insulating sealing disk in place within said housing; wherein the peripheral edge of the insulating sealing disk is crimped over the peripheral edge of both said end cap and the peripheral edge of said metal support disk thereby locking said metal support disk and said end cap in place within said insulating sealing disk; wherein said insulating sealing disk has a portion of its surface underlying said aperture in said support disk when the cell is viewed in vertical position with the end cap assembly on top, said portion of said insulating disk underlying said aperture having a groove on a side of its surface facing the cell interior, said groove having an open end and opposing closed base wherein the base of said groove forms a thinned rupturable membrane abutting said aperture in said support disk, whereby when gas pressure within the cell rises, said rupturable membrane penetrates through said aperture in said metal support disk and ruptures thereby releasing gas from the cell interior through said aperture.

2. The cell of claim 1 wherein the end cap is in juxtaposed and spaced apart relationship with said rupturable membrane thereby providing space between said end cap and said membrane, into which space said membrane can rupture.

3. The cell of claim 2 wherein said end cap comprises at least one vent aperture therethrough so that when said membrane ruptures, gas from within the cell can pass into said space between the end cap and the membrane and then through said vent aperture and out to the external environment.

4. The cell of claim 1 wherein said groove on said insulating disk surface circumvents the center of said sealing disk.

5. The cell of claim 1 wherein said rupturable membrane formed by said groove has a width to thickness ratio of between about 2.5 to 1 and 12.5 to 1.

6. The cell of claim 5 wherein the rupturable membrane at the based of said groove has a thickness of between about 0.08 and 0.25 mm.

7. The cell of claim 1 wherein the housing comprises steel and said housing has a wall thickness between 4 and 8 mils (0.10 and 0.20 mm).

8. The cell of claim 1 wherein the housing comprises steel and said housing has a wall thickness between 10 and 12 mils (0.25 and 0.30 mm).

9. The cell of claim 1 wherein a portion of the insulating disk contacts said support disk in the region of a surface of said support disk immediately adjacent said aperture.

10. The cell of claim 1 wherein the metal support disk has a central aperture located at the center of said support disk and at least a portion of the elongated current collector passes through said central aperture and the head of said current collector is welded to said end cap.

11. The cell of claim 1 wherein said insulating sealing disk comprises a plastic material having a downwardly extending surface slanted at an angle less than 90 degrees from the cell's central longitudinal axis and not parallel to said longitudinal axis, said downwardly extending surface of said insulating disk extends downwardly from a high point thereon to low point thereon, said high point being closer to the cell's central longitudinal axis than said low point when the cell is viewed in vertical position with the end cap assembly on top, wherein said support disk has a downwardly extending surface slanted at an angle less than 90 degrees from the cell's central longitudinal axis and not parallel to said longitudinal axis, said downwardly extending surface of the support disk extends downwardly from a high point thereon to low point thereon, said high point being closer to the cell's central longitudinal axis than said low point when the cell is viewed in vertical position with the end cap assembly on top, wherein the downwardly extending surface of the insulating disk underlies and abuts at least a substantial portion of the downwardly extending surface of said support disk, wherein said at least one aperture penetrates through said downwardly extending surface of said support disk, wherein a portion of said rupturable membrane underlies and abuts said aperture.

12. The cell of claim 11 wherein the downwardly slanted surface of said insulating sealing disk is slanted at an angle of between about 35 and 80 degrees from the cell's central longitudinal axis.

13. The cell of claim 12 wherein said downwardly extending surface of said support disk is slanted from the cell's central longitudinal axis at the same angle as said downwardly extending surface of the insulating sealing disk.

14. The cell of claim 12 wherein the average space between the downwardly extending surface of said metal support disk and said underlying and abutting downwardly extending surface of said insulating sealing disk is no more than about 0.5 mm.

15. The cell of claim 12 wherein the average space between the downwardly extending surface of said metal support disk and said underlying and abutting downwardly extending surface of said insulating sealing disk is between about 0.1 and 0.5 mm.

16. The cell of claim 1 wherein said aperture in said metal support disk has an area between about 2.5 and 16 mm² and said rupturable membrane at the base of said groove has a thickness between about 0.08 and 0.25 mm.

17. The cell of claim 1 wherein the end cap assembly does not include an insulating washer between said end cap and said metal support disk.

18. The cell of claim 1 wherein the support disk has a pair of opposing apertures in the downwardly extending surface of said disk.

19. The cell of claim 11 wherein the support disk has a peripheral outer edge and a substantially flat central portion with a central aperture through said central portion, wherein said central portion is at right angle to the cell's central longitudinal axis and said downwardly extending surface of the support disk extends downwardly from said central portion to said peripheral outer edge.

20. The cell of claim 19 wherein the peripheral edge of said support disk and the peripheral edge of said end cap bite into the peripheral edge of said insulating sealing disk and exert radial compressive forces on said sealing disk.

21. The cell of claim 1 wherein said insulating sealing disk and said rupturable membrane therein comprises nylon.

22. The cell of claim 1 wherein the cell is an AAA size cell.

23. The cell of claim 1 wherein the cell is an AA size cell.

24. In an electrochemical cell comprising a housing having an open end an opposing closed end and cylindrical side wall therebetween and an end cap assembly inserted into the open end of said housing closing said housing, said cell having a positive and a negative terminal, said end cap assembly comprising an electrically insulating sealing disk, said insulating sealing disk having an elongated electrically conductive current collector passing therethrough, the current collector being in electrical contact with a cell terminal, the improvement comprising:
wherein the end cap assembly comprises an insulating sealing disk, a support disk comprising metal overlying said insulating sealing disk, and an end cap comprising metal overlying said metal support disk, and an elongated current collector in electrical contact with said end cap, when the cell is viewed in vertical position with the end cap assembly on top, wherein said insulating sealing disk electrically insulates the support disk and end cap from the cell housing; wherein said housing has an edge at the open end thereof and said insulating sealing disk, metal support disk, and end cap each have a peripheral edge; wherein said support disk is of single piece metallic construction having at least one aperture therethrough; wherein the edge of said housing at the open end thereof is crimped over the peripheral edge of said insulating sealing disk locking said insulating sealing disk in place within said housing; wherein the peripheral edge of the insulating sealing disk is crimped over the peripheral edge of both said end cap and the peripheral edge of said metal support disk thereby locking said metal support disk and said end cap in place within the said insulating sealing disk; wherein said insulating sealing disk has a portion of its surface underlying said aperture in said support disk when the cell is viewed in vertical position with the end cap assembly on top, said portion of said insulating disk underlying said aperture having a groove on a side of its surface facing the cell interior, said groove having an open end and opposing closed base wherein the base of said groove forms a thinned rupturable membrane abutting said aperture in said support disk, whereby when gas pressure within the cell rises, said rupturable membrane penetrates through said aperture in said metal support disk and ruptures thereby releasing gas from the cell interior through said aperture.

25. The cell of claim 24 wherein the end cap is in juxtaposed and spaced apart relationship with said membrane thereby providing space therebetween into which space said membrane can rupture.

26. The cell of claim 25 wherein said end cap comprises at least one vent aperture therethrough so that when said membrane ruptures, gas from within the cell can pass into said space between the end cap and the membrane and then through said vent aperture and out to the external environment.

27. The cell of claim 24 wherein said groove on said insulating disk surface circumvents the center of said sealing disk.

28. The cell of claim 24 wherein said rupturable membrane formed by said groove has a width to thickness ratio of between about 2.5 to 1 and 12.5 to 1.

29. The cell of claim 28 wherein the rupturable membrane at the based of said groove has a thickness of between about 0.08 and 0.25 mm.

30. The cell of claim 24 wherein the housing comprises steel and said housing has a wall thickness between 4 and 12 mils (0.10 and 0.30 mm).

31. The cell of claim 24 wherein a portion of the insulating disk contacts said support disk in the region of a surface of said support disk immediately adjacent said aperture.

32. The cell of claim 24 wherein the metal support disk has a central aperture located at the center of said support disk and at least a portion of the elongated current collector passes through said central aperture and the head of said current collector is welded to said end cap.

33. The cell of claim 24 wherein said insulating sealing disk comprises a plastic material having a downwardly extending surface slanted at an angle less than 90 degrees from the cell's central longitudinal axis and not parallel to said longitudinal axis, said downwardly extending surface of said insulating disk extends downwardly from a high point thereon to low point thereon, said high point being closer to the cell's central longitudinal axis than said low point when the cell is viewed in vertical position with the end cap assembly on top, wherein said support disk has a downwardly extending surface slanted at an angle less than 90 degrees from the cell's central longitudinal axis and not parallel to said longitudinal axis, said downwardly extending surface of the support disk extends downwardly from a high point thereon to low point thereon, said high point being closer to the cell's central longitudinal axis than said low point when the cell is viewed in vertical position with the end cap assembly on top, wherein the downwardly extending surface of the insulating disk underlies and abuts at least a substantial portion of the downwardly extending surface of said support disk, wherein said at least one aperture penetrates through said downwardly extending surface of said support disk, wherein a portion of said rupturable membrane underlies and abuts said aperture.

34. The cell of claim 33 wherein the downwardly slanted surface of said insulating sealing disk is slanted at an angle of between about 35 and 80 degrees from the cell's central longitudinal axis.

35. The cell of claim 34 wherein said downwardly extending surface of said support disk is slanted from the cell's central longitudinal axis at the same angle as said downwardly extending surface of the insulating sealing disk.

36. The cell of claim 34 wherein the average space between the downwardly extending surface of said metal support disk and said underlying and abutting downwardly extending surface of said insulating sealing disk is no more than about 0.5 mm.

37. The cell of claim 34 wherein the average space between the downwardly extending surface of said metal support disk and said underlying and abutting downwardly extending surface of said insulating sealing disk is between about 0.1 and 0.5 mm.

38. The cell of claim 24 wherein said aperture in said support has an area between about 2.5 and 16 mm² and said rupturable membrane at the base of said groove has a thickness between about 0.08 and 0.25 mm.

39. The cell of claim 24 wherein the end cap assembly does not include an insulating washer between said end cap and said metal support disk.

40. The cell of claim 24 wherein support disk has a pair of opposing apertures in the downwardly extending surface of said disk.

41. The cell of claim 33 wherein the support disk has a peripheral outer edge and a substantially flat central portion with a central aperture through said central portion, wherein said central portion is at right angle to the cell's central longitudinal axis and said downwardly extending surface of the support disk extends downwardly from said central portion to said peripheral outer edge.

42. The cell of claim 41 wherein the peripheral edge of said support disk and the peripheral edge of said end cap bite into the peripheral edge of said insulating sealing disk and exert radial compressive forces on said sealing disk.

43. The cell of claim 24 wherein said insulating sealing disk and said rupturable membrane therein comprises nylon.

44. The cell of claim 24 wherein the cell is an AAA size cell.

45. The cell of claim 24 wherein the cell is an AA size cell.
